(19) United States
(12) Patent Application Publication
(10) Pub. No.: US 2008/0076018 A1
(43) Pub. Date: Mar. 27, 2008

(54) Core Structure for a Circular Lithium Secondary Battery

(76) Inventor: Donald P. H. WU, Hsin-Feng Hsiang (TW)

Correspondence Address: Dr. BANGER SHIA, 102 Lindencrest Ct., Sugar Land, TX, 77479-5201, US

(21) Appl. No.: 11/534,233

(22) Filed: Sep. 22, 2006

(51) Int. Cl. H01M 2/26

(52) U.S. Cl. 429/161; 429/211; 429/164; 429/94

(57) ABSTRACT

A core structure for a circular lithium secondary battery is disposed in a case of the battery and comprises: a core, an electrode assembly, and two conductive fixing assemblies. A connecting member serves as an electrical conductive connection for connecting the conductive pressing pieces to the positive lead terminal or the negative lead terminal, and the connecting member is a curved flexible structure. By such arrangements, even if there is a dimension error in the core or the case, which can be overcome by the deformation of the connecting member, and thus the battery can be assembled successfully.

### BACKGROUND OF THE INVENTION

1. Field of the Invention

The present invention relates to a core structure for a circular lithium secondary battery, and more particularly to the design of the connection between the energy collecting and outputting structure of an electrode assembly, the core and the lead terminals of a battery.

2. Description of the Prior Art

FIGS. 1 and 2 show “an electrode assembly for a lithium secondary battery” disclosed in an earlier U.S. patent application Ser. No. 11/455119 of the inventor, and the earlier application mainly aims at the solution to the problem of the conventional electrode assembly, including the time consuming welding process, the complicated components and the production process, since the electrode assembly must be formed or welded with a plurality of leads, and then the leads are welded or connected to the battery terminal.

The positive and negative layers of the electrode assembly 10 are formed at a side thereof with a large negative lead area 11 and a large uncoated positive lead area 12. In addition, a large collecting area 131 is formed in the mid of the lead terminal 13 and is located correspondingly to the negative lead area 11 or the positive lead area 12. And then clasping assemblies 14 are fixed outside the positive lead area 11 or the negative lead area 12. In this way, the two conductive pressing pieces 141 are firmly pressed against the positive lead area 11 or the negative lead area 12. On the one hand, the respective layers of the positive lead area 11 or the negative lead area 12 are pressed closely against one another, and on the other hand, the positive lead area 11 or the negative lead area 12 is allowed to be maintained in a tight electrical contact with the collecting area 131 (as shown in FIG. 2).

It is to be noted that the size of the respective components of the abovementioned lithium secondary battery must be controlled precisely; otherwise, the electrode assembly cannot be fitted into the battery case, if the battery case, the core or the lead terminal has an error in dimension. For example, if the battery case is too short or the core is too high, the core cannot be sealed hermetically in the battery case, or, if the electrode assembly is too short, as a result, only one end of the electrode assembly can be fixed to the battery case, and the other end of the electrode assembly will be too short to reach the battery case, so it cannot be fixed.

It is learned from the abovementioned explanation that the earlier application simplifies the electrical connection process of the leads of the electrode assembly. However, the size of the components of the electrode assembly must be controlled precisely, otherwise the electrode assembly cannot be assembled.

The present invention has arisen to mitigate and/or obviate the afore-described disadvantages.

### SUMMARY OF THE INVENTION

The primary objective of the present invention is to provide a core structure for a circular lithium secondary battery. A connecting member serves as an electrical conductive connection for connecting the conductive pressing pieces to the positive lead terminal or the negative lead terminal, and the connecting member is a curved flexible structure. By such arrangements, even if there is a dimension error in the core or the case, which can be overcome by the deformation of the connecting member, and thus the battery can be assembled successfully.

### BRIEF DESCRIPTION OF THE DRAWINGS

FIG. 1 is an exploded view of a conventional core structure for a secondary lithium battery disclosed in U.S. application Ser. No. 11/456119;

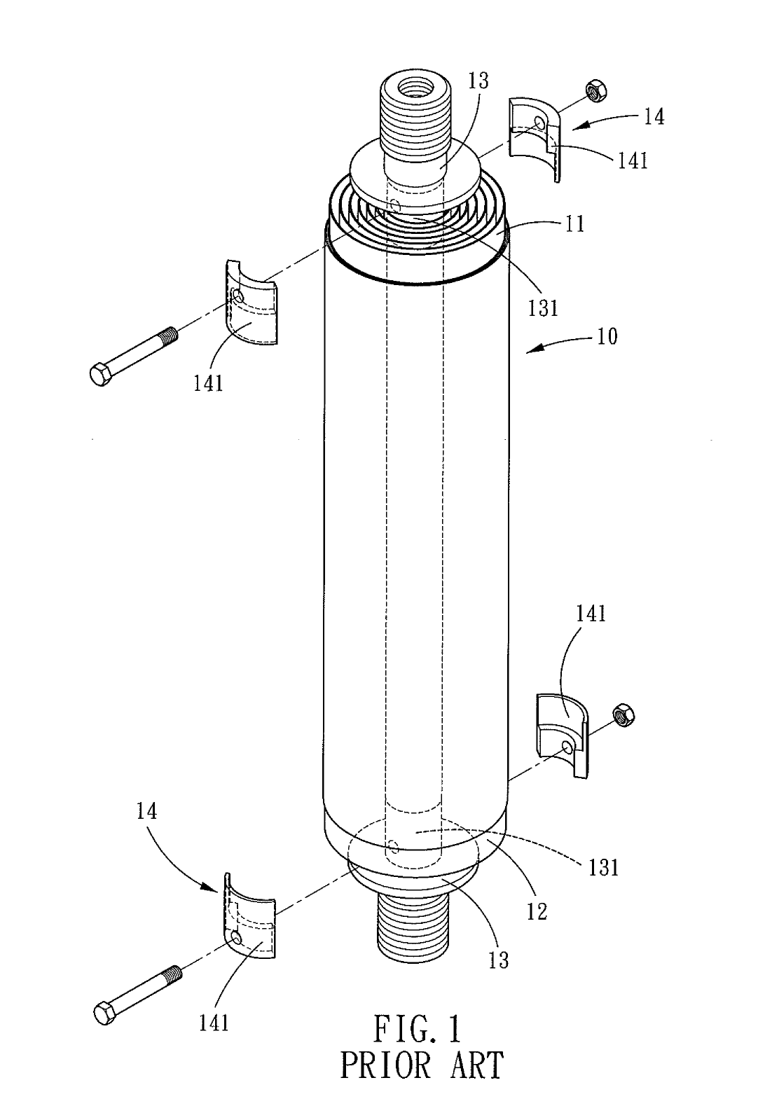

FIG. 2 is an enlarged view of a part of the conventional core structure for a secondary lithium battery disclosed in U.S. application Ser. No 11/456119;

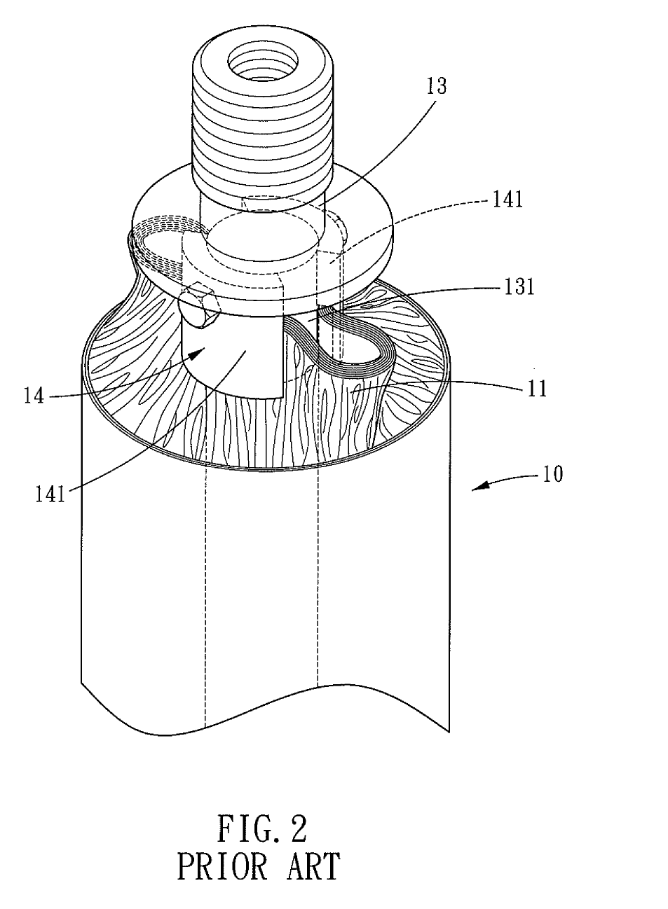

FIG. 3 is a perspective view of showing a core structure for a secondary lithium battery in accordance with the present invention;

FIG. 4 is an exploded view of showing the core structure for a secondary lithium battery in accordance with the present invention;

FIG. 5 is an enlarged view of showing a part of the core structure for a secondary lithium battery in accordance with the present invention;

FIG. 6 is a cross sectional view in accordance with the present invention of showing the interior of the battery case; and

FIG. 7 is a cross sectional view in accordance with the present invention of showing the interior of the battery case, wherein the core structure is additionally provided with conductive sleeve.

### DETAILED DESCRIPTION OF THE PREFERRED EMBODIMENT

The present invention will be more clear from the following description when viewed together with the accompanying drawings, which show, for purpose of illustrations only, the preferred embodiment in accordance with the present invention.

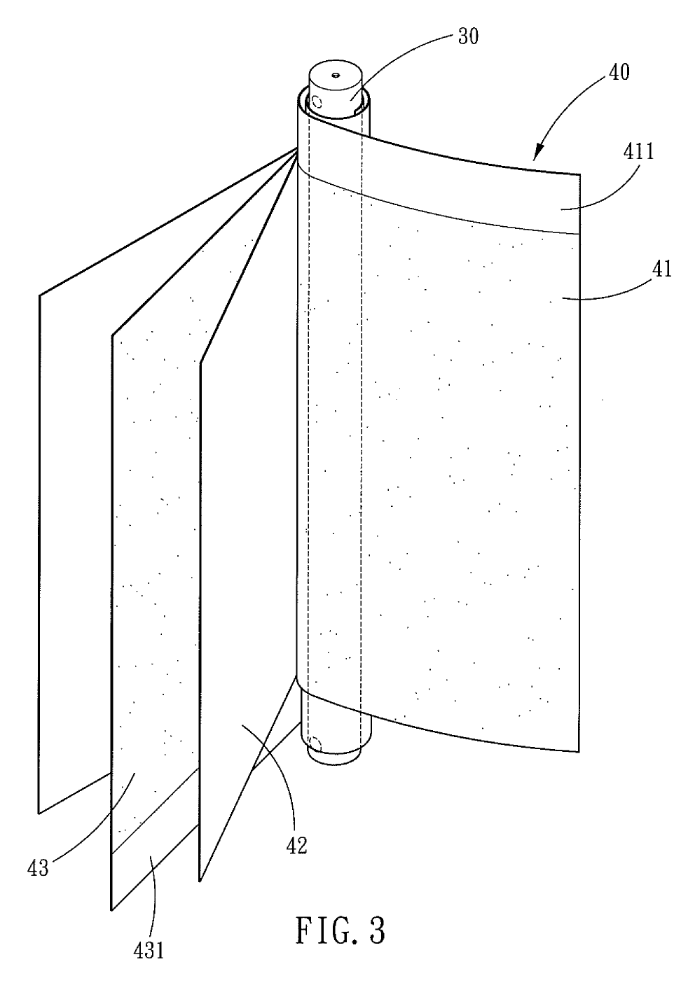

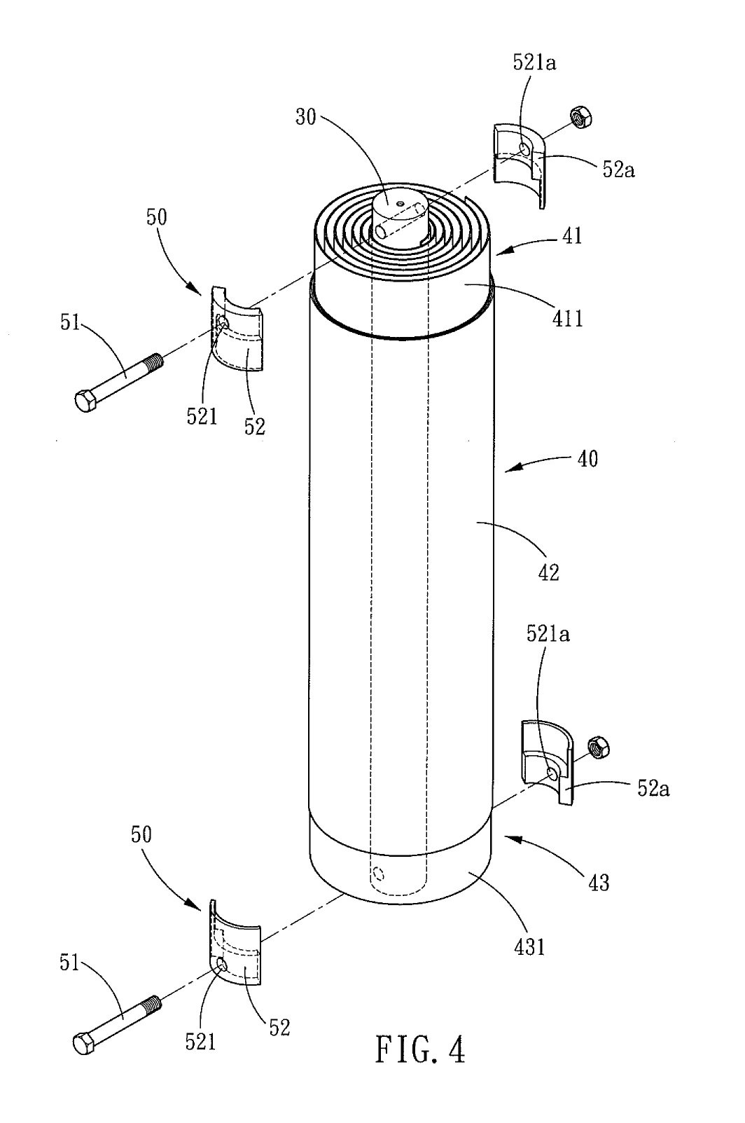

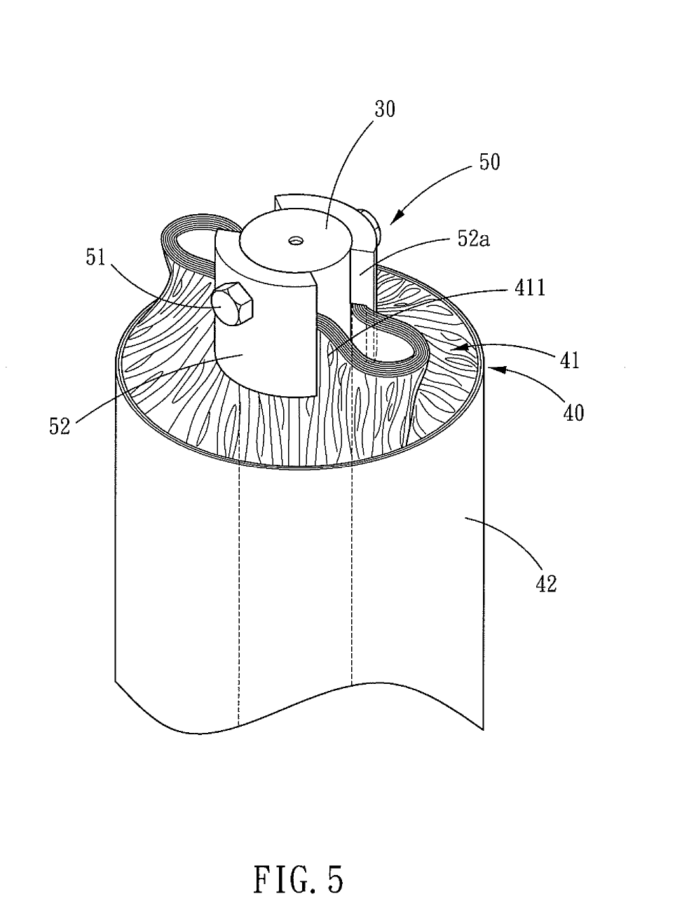

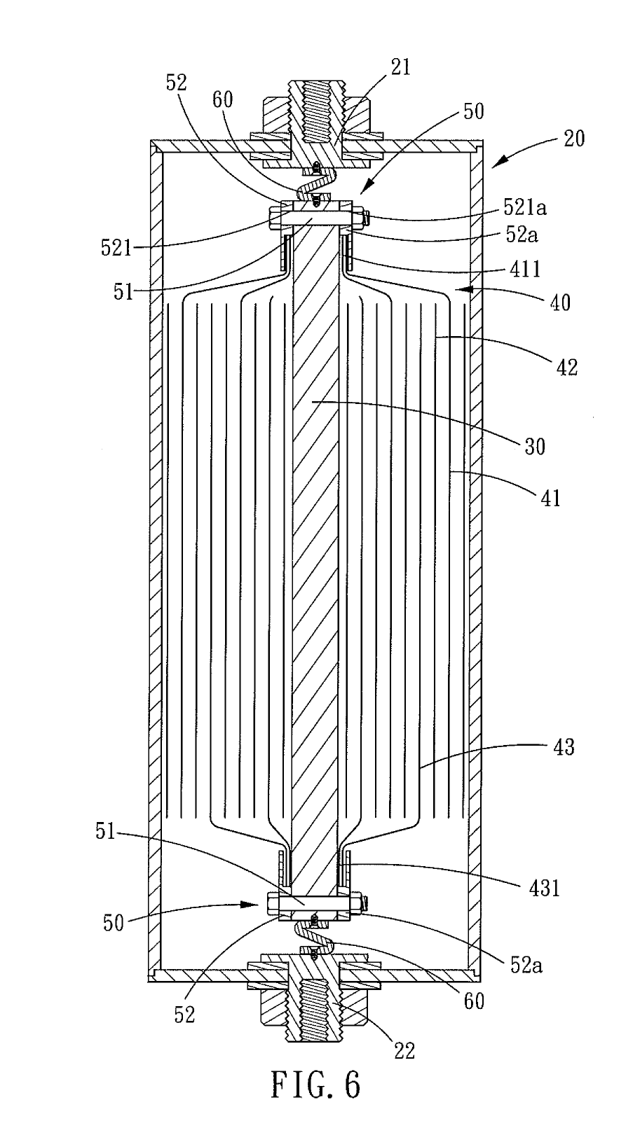

Referring to FIGS. 3-6, a core structure for a circular secondary lithium battery in accordance with the present invention is shown and comprises: a core, an electrode assembly, and two conductive fixing assemblies. The core assembly is disposed in a case 20 and is electrically connected to the positive and negative lead terminals on the caps of the case 20 by two conductive connecting members.

The core 30 is disposed in the case 20.

The electrode assembly 40 includes at least one positive layer 41, one separating layer 42 and one negative layer 43 that are superposed one another and then wind around the core 30. The surfaces of the positive and negative electrode layers 41, 43 are coated with positive electrode material and negative electrode material, respectively. The separating layer 42 is located between the positive and negative electrode layers 41, 43. An uncoated area is formed at a side of the positive layer 41 for use as a positive lead area 411, and the negative layer 42 is formed at another side thereof opposite the positive layer 41 with an uncoated area for use as a negative lead area 431. The positive and negative lead areas 411 and 431 protrude out of both sides of the assembly of positive layer 41, the separating layer 43 and the negative layer 42. After the electrode assembly 40 is formed by winding the positive layer 41, the separating layer 42 and the negative layer 43 around the core 30, the positive and negative lead areas 411 and 431 will protrude out of both ends of the electrode assembly 40.

Each of the conductive fixing assemblies 50 includes a fastener 51 and two conductive pressing pieces 52. The conductive pressing pieces 52 each is formed with a through hole 521 and is disposed outside the positive lead area 411 or the negative lead area 431. The fastener can be a bolt and is inserted through the through hole 521 of one of the conductive pressing pieces 52, the core 30, and the through hole 521 of another one of the conductive pressing pieces 52, and then is fixed thereto by a nut, so that the two conductive pressing pieces 52 are fixed on the core 30 and are firmly pressed against the positive lead area 411 or the negative lead area 431, and the positive lead area 411 or the negative lead area 431 are maintained in a close electrical contact with the conductive pressing pieces 52.

Each of the connecting members 60 is conductive and flexible and has one end electrically connected to the conductive pressing pieces 52 of the electrode assembly 40 and has another end electrically connected to the positive lead terminal 21 or the negative lead terminal 22.

The core structure and the arrangement relation of the components thereof are mentioned above. The present invention intends to further improve the design of the core structure and to use the connecting member as an electrical conductive connection for connecting the conductive pressing pieces to the positive lead terminal or the negative lead terminal, and the connecting member is a curved flexible structure. By such arrangements, even if there is a dimension error in the core or the case, which can be overcome by the deformation of the connecting member, and thus the battery can be assembled successfully.

Referring to FIGS. 3-6 again, the connecting members 60 serve as electrical conductive connection between the core and the positive lead terminal 21 or the negative lead terminal 22. Since each of the connecting members 60 is flexible, it can be deformed or lengthened to a certain extent. Therefore, even if there is a dimension error in the core or the case 20, which can be overcome by the deformation of the connecting member 60, and thus the core and the case 20 can be assembled successfully.

It is to be noted that the design of the present invention makes the core structure very simple, and the electrode assembly is connected to the positive lead terminal 21 and the negative lead terminal 22 directly by the conductive pressing pieces 52 and the connecting members 60. Since the number of the connecting members and the conductive pressing pieces 52 is very small, which contributes to reduction of the resistance of the battery.

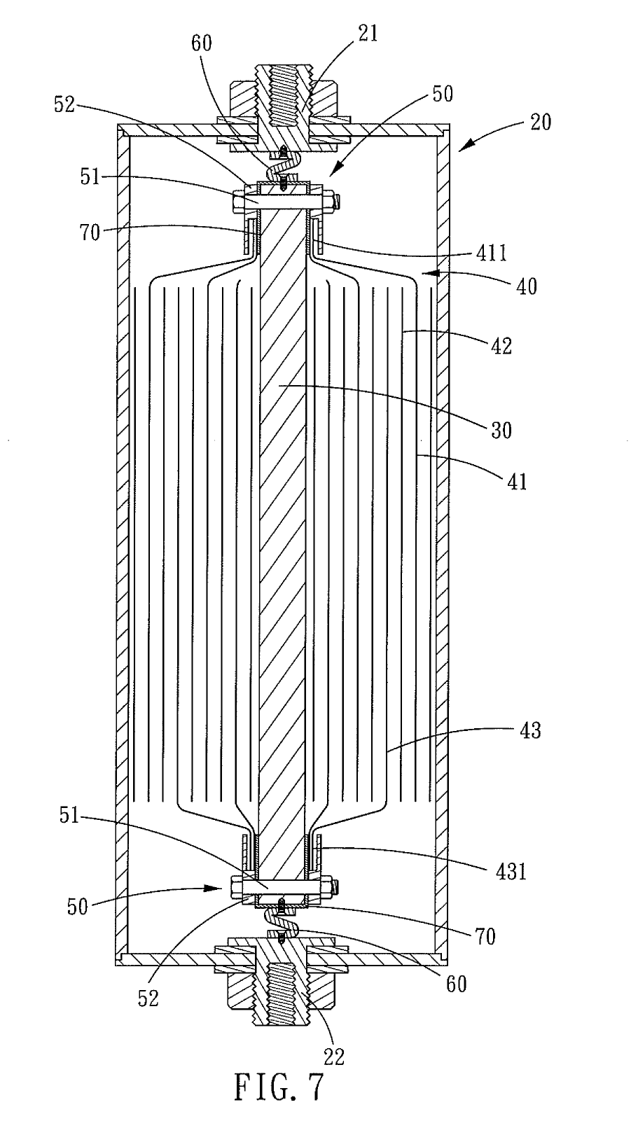

As shown in FIG. 7, either end of the core 30 can be covered with a conductive sleeve 70, when the conductive pressing pieces 52 are pressed against the positive and negative lead areas 411, 431, the conductive sleeve 70 can improve the electrical connection between the pressing surfaces of the positive and negative lead areas 411, 431, thus increasing the current path in the charge and discharge process of the battery, and reducing the resistance of the battery.

While we have shown and described various embodiments in accordance with the present invention, it is clear to those skilled in the art that further embodiments may be made without departing from the scope of the present invention.

What is claimed is:

1. A core structure for a circular lithium secondary battery being disposed in a case of the battery and electrically connected to positive and negative terminals of the battery by two connecting members, the core structure comprising:
a core disposed in the case;
an electrode assembly including at least one positive layer, one separating layer and one negative layer, wherein the positive layer, the separating layer and the negative layer are superposed one another and wind around the core, an uncoated area is formed at a side of the positive layer for use as a positive lead area, and the negative layer is formed at another side thereof opposite the positive layer with an uncoated area for use as a negative lead area, the positive and negative lead areas protrude out of both sides of the electrode assembly, respectively;
two conductive fixing assemblies each including at least one fastener and at least one conductive pressing piece, wherein the conductive pressing piece is disposed outside the positive lead area or the negative lead area, the conductive pressing piece is fixed on the core by inserting the fastener through the through hole of the conductive pressing piece, so that the conductive pressing piece is firmly pressed against the positive lead area or the negative lead area, and the positive lead area or the negative lead area is maintained in a close electrical contact with the conductive pressing piece, the conductive fixing assemblies are initially connected to the connecting members and then electrically connected to the positive lead terminal or the negative lead terminal.

2. The core structure for a circular lithium secondary battery as claimed in claim 1, wherein the conductive connecting members are a flexible wire.

3. The core structure for a circular lithium secondary battery as claimed in claim 1, wherein two conductive pressing pieces are disposed outside the positive lead area or the negative lead area, and the conductive pressing pieces are firmly pressed against the positive lead area or the negative lead area from both sides by inserting the fastener through one of the conductive pressing pieces, the core, and another one of the conductive pressing pieces, respectively, and the positive lead area or the negative lead area is maintained in a close electrical contact with the conductive pressing pieces.

4. The core structure for a circular lithium secondary battery as claimed in claim 1, wherein either end of the core is covered with a conductive sleeve, when the conductive pressing piece is pressed against the positive lead area or the negative lead area, the conductive sleeve can improve electrical connection between pressing surfaces of the positive lead area and negative lead area.
